(19) United States
(12) Patent Application Publication
(10) Pub. No.: US 2005/0024321 A1
(43) Pub. Date: Feb. 3, 2005

(54) Handheld remote instruction device for a computer-based visual presentation system

(76) Inventor: Huo-Lu Tsai, Taichung Hsien (TW)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 10/627,720

(22) Filed: Jul. 28, 2003

(51) Int. Cl. G09G 5/00

(52) U.S. Cl. 345/156

(57) ABSTRACT

A handheld remote instruction device for a computer-based visual presentation system includes a housing, a light emitting module, a keypad, a control unit, a wireless signal transmitter, and a wireless signal receiver. The keypad includes first and second function keys, and a mode switching key for switching between first and second key defining modes for the first and second function keys. A corresponding control signal transmitted by the signal transmitter and received by the signal receiver when either of the first and second function keys is pressed thus depends on the key defining mode set by the mode switching key. Particularly, the control signals generated when the first and second function keys are pressed are associated with a Click/Select command and a Context Menu/Alternate command in the first key defining mode, and with a Page Down command and a Page Up command in the second key defining mode.

### BACKGROUND OF THE INVENTION

1. Field of the Invention

The invention relates to a handheld remote instruction device, more particularly to a handheld remote instruction device for a computer-based visual presentation system.

2. Description of the Related Art

With the prevalence of computers, computer-aided presentations have grown in popularity. When making a visual presentation with the use of a computer, a computer mouse is a primary tool for cursor control during the presentation. In general, during the progress of executing presentation software, the most frequently used commands include a Click/Select command issued upon clicking a left button of the mouse, a Context Menu/Alternate Select command issued upon clicking a right button of the mouse, and Page Up and Page Down commands issued upon pressing corresponding keys on a computer keyboard.

If the presentation is made through constant or frequent operation of a mouse or a keyboard in front of a computer without focusing on the audience, interaction and communication between the presenter and the audience will be poor. To improve the effectiveness of computer-aided presentations, a handheld remote instruction device for a computer-based visual presentation system has been proposed heretofore. With the use of the device, the presenter can remotely control the computer so as to be able to conduct presentations while standing in front of a display screen.

Referring to FIG. 1, a conventional handheld remote instruction device for a computer-based visual presentation system (not shown) is shown to include a housing 1 having a front side 11 with a light emitting member 12 mounted thereon, a top side 10 provided with a power switch key 13, a cursor control key 14, a pair of function keys 15, 16, and a configure key 17 thereon, and a lateral side 18 provided with a rotary knob 19. The power switch key 13 is operable so as to control light emitting activity of the light emitting member 12 for pointing purposes. The functions associated with the function keys 15, 16 are the same as those of the left and right buttons of a conventional computer mouse. That is, the function keys 15, 16 are respectively associated with a Click/Select command and a Context Menu/Alternate Select command for the visual presentation system. The configure key 17 may be used to lock the power switch key 13, thereby disabling the light emitting member 12. The configure key l7 may further cooperate with the rotary knob 19 for reset initialization and for identification recognition with a signal receiver (not shown). The rotary knob 19 can be operated to generate control signals associated with Line Up and Line Down commands for the visual presentation system. It is thus apparent that the known handheld remote instruction device provides functions, such as light emission for pointing during presentations, cursor movement control, and Click/Select, Context Menu/Alternate Select, Line Up, and Line Down command generation, etc.

However, there are still some drawbacks associated with the use of the conventional handheld remote instruction device. Particularly, the functions associated with the function keys 15, 16 are limited to the Click/Select and Context Menu/Alternate Select commands. To provide added functionality, a number of function keys corresponding to the added functions must be provided, thereby resulting in an adverse affect on the size and the design of the housing 1 of the device. Moreover, the rotary knob 19 on the lateral side 18 of the housing 1 is not designed for convenient use by both left-handed and right-handed users. Moreover, since Page Up and Page Down commands are more frequently used than Line Up and Line Down commands when making presentations, key function assignment is not optimized in the aforesaid conventional handheld remote instruction device.

### SUMMARY OF THE INVENTION

Therefore, the object of the present invention is to provide a handheld remote instruction device for a computer-based visual presentation system that can overcome the aforesaid drawbacks associated with the prior art.

According to the present invention, a handheld remote instruction device for a computer-based visual presentation system comprises a housing, a light emitting module, a keypad, a control unit, a wireless signal transmitter, and a wireless signal receiver.

The light emitting module is mounted on the housing, and includes a light emitting element and a control switch for controlling light emitting activity of the light emitting element. The keypad is disposed on the housing, and includes a set of keys which include a cursor control key, a first function key, a second function key, and a mode switching key. The control unit is mounted in the housing, and is connected to the light emitting module and the keypad. The wireless signal transmitter is mounted in the housing, and is connected to the control unit. The control unit enables the wireless signal transmitter to transmit a corresponding control signal in response to pressing of one of the keys of the keypad. The wireless signal receiver is adapted to be connected to the visual presentation system, and is operable so as to receive the control signal transmitted by the wireless signal transmitter and so as to provide the control signal to the visual presentation system.

The mode switching key is operable so as to control operation of the control unit in a selected one of first and second key defining modes. The control unit enables the signal transmitter to transmit a first control signal when the first function key is pressed while the control unit is operated in the first key defining mode, to transmit a second control signal when the second function key is pressed while the control unit is operated in the first key defining mode, to transmit a third control signal when the first function key is pressed while the control unit is operated in the second key defining mode, and to transmit a fourth control signal when the second function key is pressed while the control unit is operated in the second key defining mode.

One of the first and second control signals is associated with a Click/Select command for the visual presentation system, and the other of the first and second control signals is associated with a Context Menu/Alternate Select command for the visual presentation system. Moreover, one of the third and fourth control signals is associated with a Page Down command for the visual presentation system, and the other of the third and fourth control signals is associated with a Page Up command for the visual presentation system.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional handheld remote instruction device for a computer-based visual presentation system;

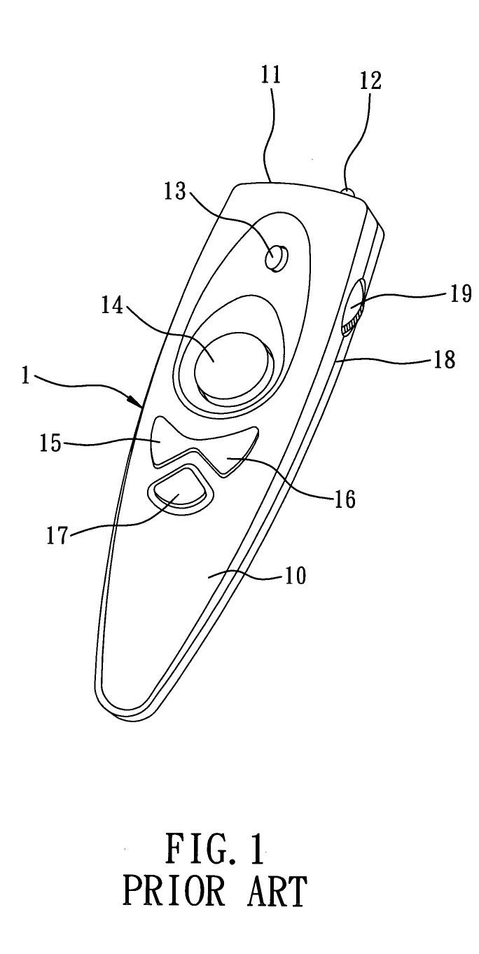

FIG. 2 is a perspective view of the preferred embodiment of a handheld remote instruction device for a computer-based visual presentation system according to this invention;

FIG. 3 is a schematic circuit block diagram of the preferred embodiment;

FIG. 4 is a schematic circuit diagram of a control unit of the preferred embodiment;

FIG. 5 is a schematic circuit diagram of a wireless signal transmitter of the preferred embodiment;

FIG. 6 is a schematic circuit diagram of a light emitting module of the preferred embodiment;

FIG. 7 is a schematic circuit diagram of a wireless signal receiver of the preferred embodiment; and

FIG. 8 is a schematic view to illustrate an electrical circuit layout disposed on a housing of the preferred embodiment.

### DETAILED DESCRIPTION OF THE PREFERRED EMBODIMENT

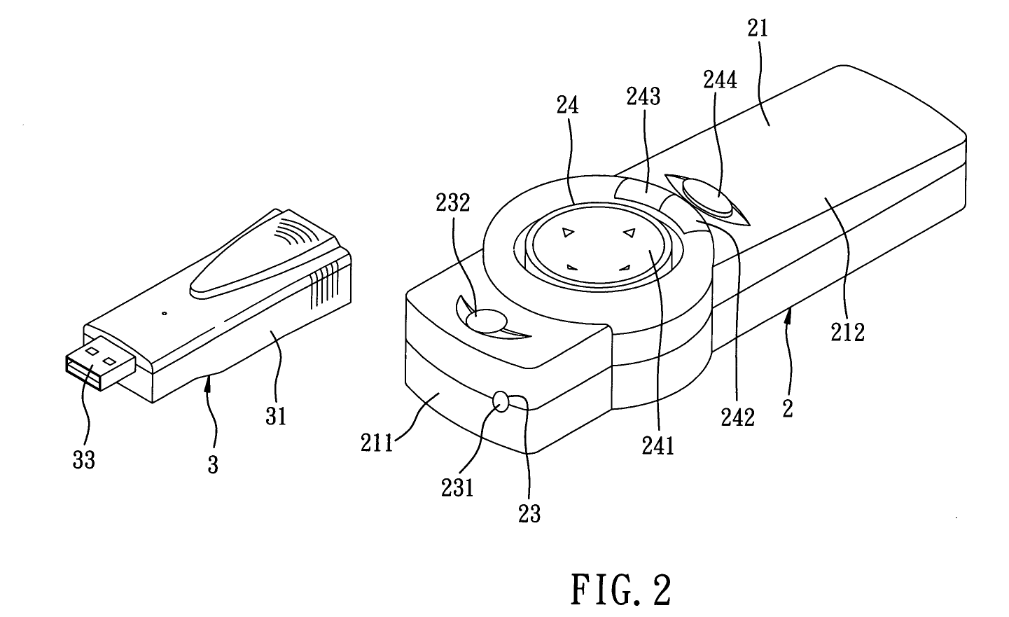

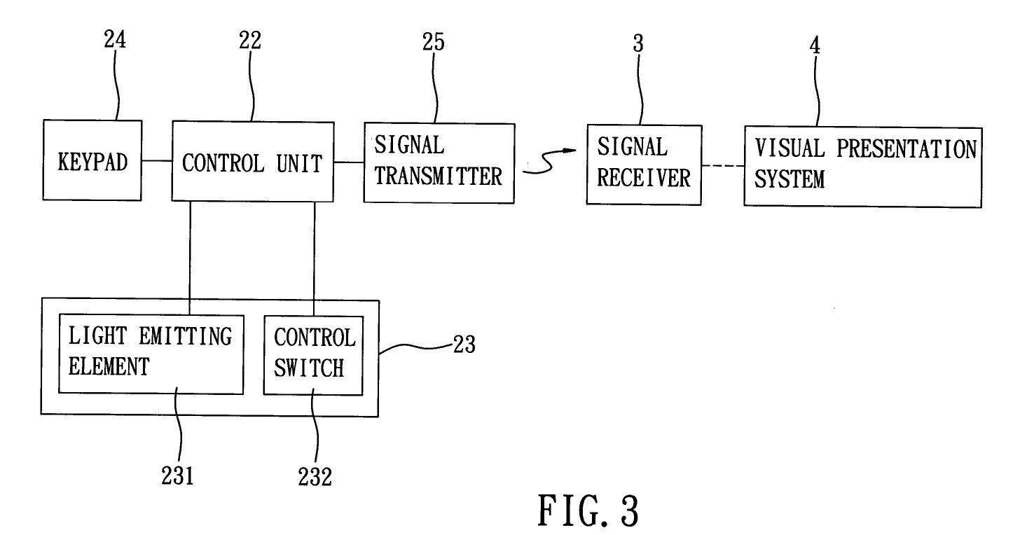

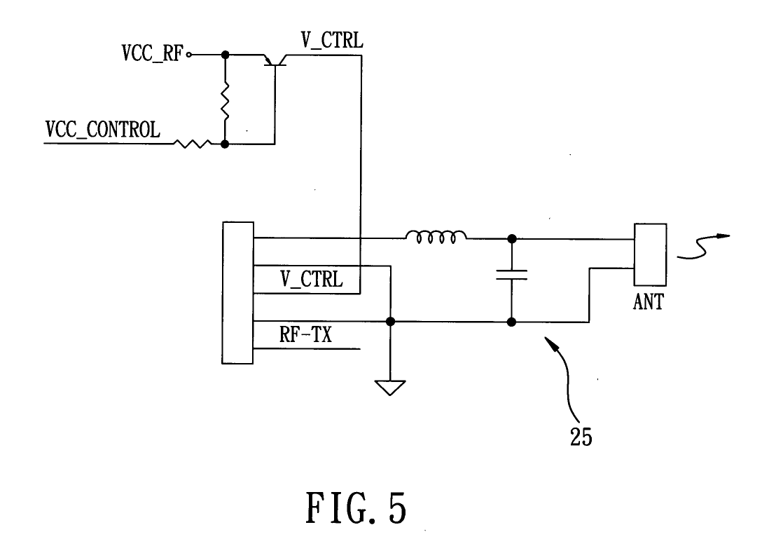

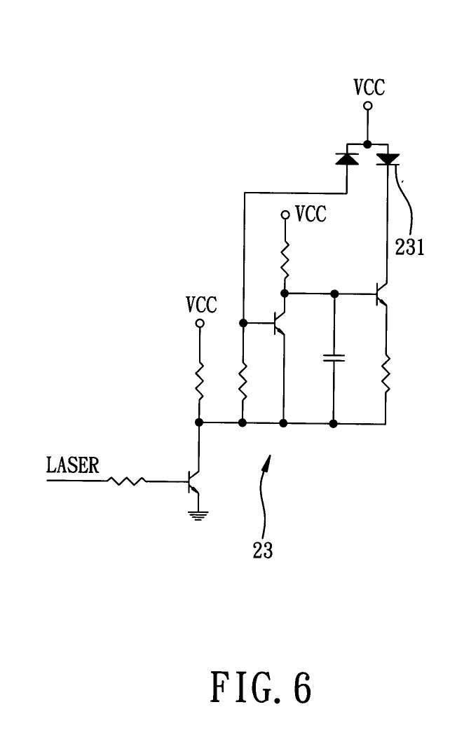

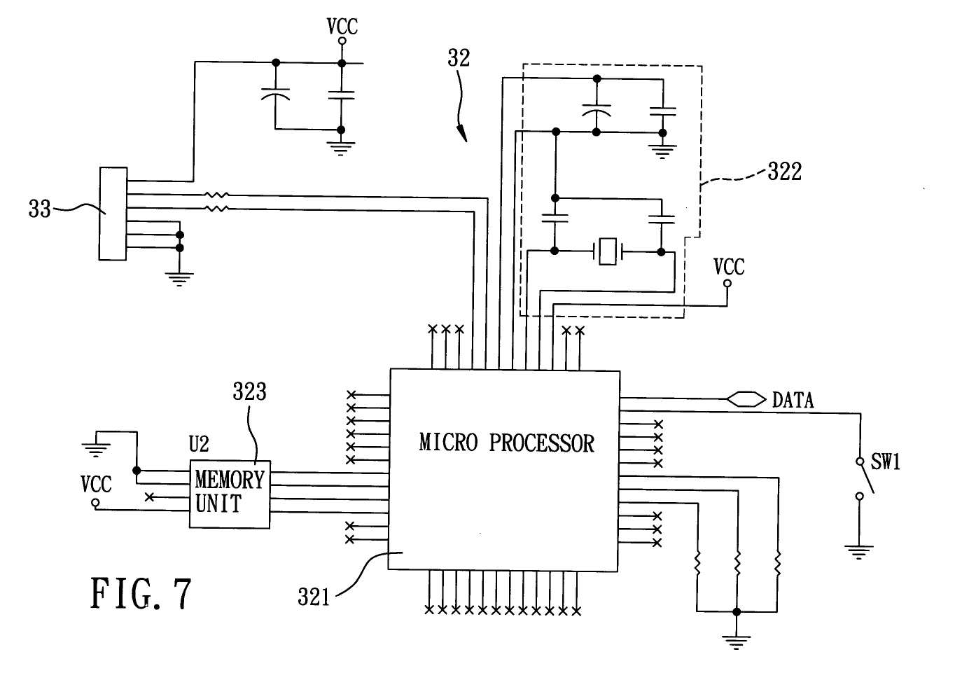

Referring to FIGS. 2 to 8, the preferred embodiment of a handheld remote instruction device 2 according to the present invention is adapted for use with a computer-based visual presentation system 4, and is shown to include a housing 21, a light emitting module 23, a keypad 24, a control unit 22, a wireless signal transmitter 25, and a wireless signal receiver 3.

The light emitting module 23 includes a light emitting element 231 mounted on a front side 211 of the housing 21, and a control switch 232 mounted on a top side 212 of the housing 2l for controlling light emitting activity of the light emitting element 231.

The keypad 24 is disposed on the top side 212 of the housing 21, and includes a set of keys. In this embodiment, the keys include a cursor control key 241, a first function key 242, a second function key 243, and a mode switching key 244.

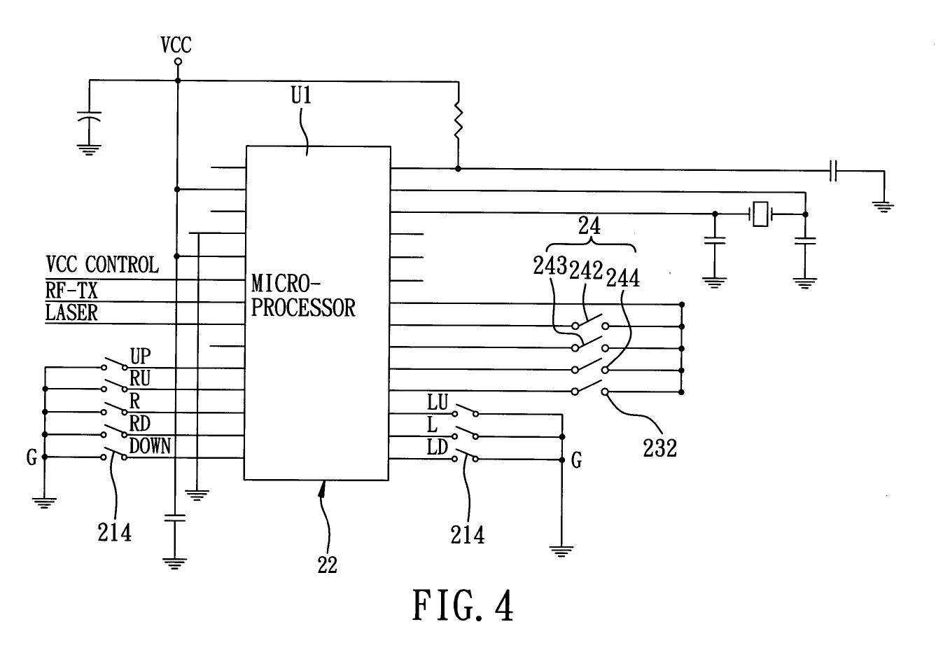

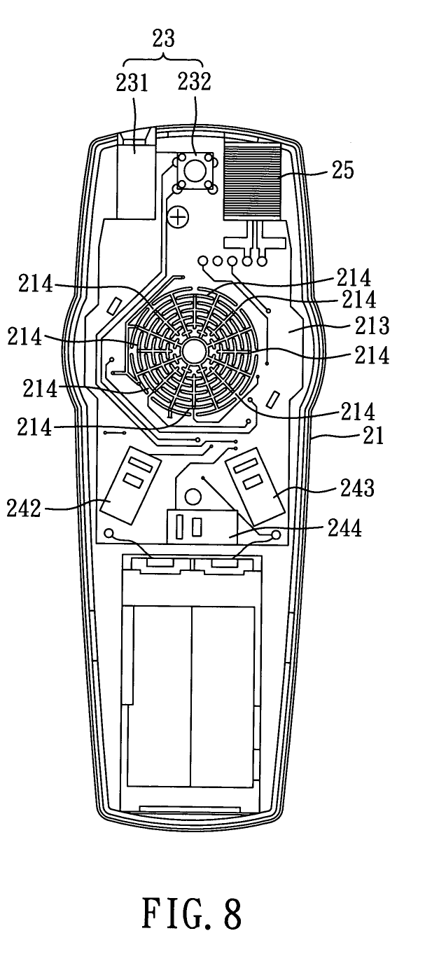

As best shown in FIGS. 4 and 8, the cursor control key 241 is operably associated with eight printed circuit switch contact sets 214 formed on a circuit board 213. Each switch contact set 214 includes a respective direction contact, such as (R), (RU), (UP), (LU), (L), (LD), (DOWN) and (RD), and a common contact (G) Accordingly, pressing of the cursor control key 241 results in bridging of a corresponding switch contact set 214 for cursor movement control.

In a first key defining mode, the first and second functions keys 242, 243 are associated with a Click/Select command and a Context Menu/Alternate Select command for the visual presentation system, respectively. In a second key defining mode, the first and second functions keys 242, 243 are associated with a Page Down command and a Page Up command for the visual presentation system, respectively. The mode switching key 244 is operable so as to control operation in a selected one of the first and second key defining modes.

The control unit 22 is mounted in the housing 21, is connected to the light emitting element 231 and the control switch 232 of the light emitting module 23, and is further connected to the keypad 24. The control unit 22 of this embodiment includes a microprocessor (U1).

As best shown in FIGS. 4, 5 and 8, the wireless signal transmitter 25 is mounted in the housing 21 and is connected to the control unit 22. Through the control of the control unit 22, i.e., VCC CONTROL from the microprocessor (U1), the wireless signal transmitter 25 transmits a corresponding control signal in response to pressing of one of the keys of the keypad 24.

As best shown in FIGS. 2, 3 and 7, the wireless signal receiver 3 is adapted to be connected to the visual presentation system 4, and is operable so as to receive the control signal transmitted by the wireless signal transmitter 25 and so as to provide the control signal to the visual presentation system 4. The wireless signal receiver 3 includes a casing 31, a signal receiving circuit 32 mounted in the casing 31, and a plug 33 electrically connected to the signal receiving circuit 32 for plugging into the visual presentation system 4. The signal receiving circuit 32 includes a microprocessor 321 for signal processing, a clock circuit 322, and a memory unit 323. In this embodiment, the plug 33 includes a Universal Serial Bus (USB) connector.

When the remote instruction device of the present invention is in use, pressing of the control switch 232 enables the control unit 22 to generate a control signal, i.e., LASER from the microprocessor (U1) , for enabling the light emitting module 23 to activate the light emitting element 231. At this time, the light emitting element 231 radiates a laser light beam for pointing indication when making a presentation.

When the cursor control key 241 is pressed, a corresponding switch contact set 214 will be bridged. By monitoring the status of the switch contact sets 214, the control unit 22 will be able to calculate cursor displacement direction and speed in a known manner. The control unit 22 then provides a cursor control signal, i.e., RF-TX from the microprocessor (U1) , to the wireless signal transmitter 25, which transmits the same for subsequent reception by the wireless signal receiver 3. The microprocessor 321 of the wireless signal receiver 3 then converts the received cursor control signal into an associated command that is provided to the visual presentation system 4 for cursor movement control. More details in connection with the cursor movement control technique that is employed in the preferred embodiment can be found in a co-pending U.S. patent application, entitled “Method and Device for Cursor Control,” filed by the applicant.

As mentioned hereinabove, the mode switching key 244 is operable so as to control operation of the control unit 22 in a selected one of the first and second key defining modes. The control unit 22 enables the wireless signal transmitter 25, such as through RF-TX of the microprocessor (U1) , to transmit a first control signal associated with the Click/Select command for the visual presentation system 4 when the first function key 242 is pressed while the control unit 22 operates in the first key defining mode, to transmit a second control signal associated with the Context Menu/Alternate Select command for the visual presentation system 4 when the second function key 243 is pressed while the control unit 22 operates in the first key defining mode, to transmit a third control signal associated with the Page Down command for the visual presentation system 4 when the first function key 242 is pressed while the control unit 22 operates in the second key defining mode, and to transmit a fourth control signal associated with the Page Up command for the visual presentation system 4 when the second function key 243 is pressed while the control unit 22 operates in the second key defining mode. The appropriate command is issued by the microprocessor 321 of the wireless signal receiver 3 to the visual presentation system 4 upon receipt of any of the first to fourth control signals from the wireless signal transmitter 25.

In sum, with the use of the remote instruction device of the present invention, a presenter can be situated in a convenient place in front of a screen when controlling the direction and speed of a cursor moving on the screen. Moreover, through the use of the mode switching key 244 for switching between definitions of the function keys 242, 243, added functionality for the remote instruction device is possible without an undue increase in the size of the housing 21. Furthermore, since all operable components (i.e., keys) are disposed on the top side 212 of the housing 21, the remote instruction device of this invention can be conveniently used by both right-handed and left-handed users.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A handheld remote instruction device for a computer-based visual presentation system, comprising:
a housing;
a light emitting module mounted on said housing and including a light emitting element and a control switch for controlling light emitting activity of said light emitting element;
a keypad disposed on said housing and including a set of keys, said keys including a cursor control key, a first function key, a second function key, and a mode switching key;
a control unit mounted in said housing and connected to said light emitting module and said keypad;
a wireless signal transmitter mounted in said housing and connected to said control unit, said control unit enabling said wireless signal transmitter to transmit a corresponding control signal in response to pressing of one of said keys of said keypad; and
a wireless signal receiver adapted to be connected to the visual presentation system and operable so as to receive the control signal transmitted by said wireless signal transmitter and so as to provide the control signal to the visual presentation system;
wherein said mode switching key is operable so as to control operation of said control unit in a selected one of first and second key defining modes;
wherein said control unit enables said signal transmitter to transmit a first control signal when said first function key is pressed while said control unit is operated in the first key defining mode, to transmit a second control signal when said second function key is pressed while said control unit is operated in the first key defining mode, to transmit a third control signal when said first function key is pressed while said control unit is operated in the second key defining mode, and to transmit a fourth control signal when said second function key is pressed while said control unit is operated in the second key defining mode;
wherein one of the first and second control signals is associated with a Click/Select command for the visual presentation system, and the other of the first and second control signals is associated with a Context Menu/Alternate Select command for the visual presentation system; and
wherein one of the third and fourth control signals is associated with a Page Down command for the visual presentation system, and the other of the third and fourth control signals is associated with a Page Up command for the visual presentation system.
